(19) United States
(12) Patent Application Publication
(10) Pub. No.: US 2010/0312704 A1
(43) Pub. Date: Dec. 9, 2010

(54) Method and Apparatus for On Demand Generation, Use and Transfer of Virtual Financial Instruments

(75) Inventor: Sanjay Rohatgi, Saratoga, CA (US)

Correspondence Address: MICHAEL TOBACK, 12200 SARAGLEN DRIVE, SARATOGA, CA, 95070, US

(73) Assignee: Mobidough, Inc, Los Gatos, CA (US)

(21) Appl. No.: 12/857,556

(22) Filed: Aug. 17, 2010

Related U.S. Application Data
(63) Continuation-in-part of application No. 12/099,713, filed on Apr. 8, 2008.

(51) Int. Cl. G06Q 40/00; G06K 19/06

(52) U.S. Cl. 705/44; 235/494

(57) ABSTRACT

Methods and systems are disclosed for enabling participants to generate, use, and transfer virtual financial instruments. The account holder requests the generation of a virtual financial instrument. The account holder selects a financial instrument to use as the source of funds for the virtual financial instrument, configures the use of the virtual financial instrument to be limited by a set of user-defined rules and expiration date, and selects a user of the instrument. The virtual instrument is transferred to the user. On request to perform a financial transaction, the user is authenticated, the transaction is validated that it is in within the limits of the user-defined rules, an authorization code is request if it is not, and the transaction is allowed. If a chargeback is necessary, the virtual financial instrument and the account is updated if the instrument has not expired, just the account otherwise.

### CLAIM OF PRIORITY AND RELATED APPLICATIONS

This application is a continuation-in-part of U.S. application Ser. No. 12/099,713 filed on Mar. 8, 2008 entitled “Integrated Mobile Transaction System and Methods Thereof”.

### BACKGROUND OF INVENTION

1. Field of the Invention

This invention generally relates to the generation, use and transfer of virtual financial instruments using mobile communication devices.

2. Background and Description of the Related Art

People need to transfer money or its equivalent between individuals or from a financial institution to an individual. For example, a transfer between a parent and a child. Currently, this can be done either by sending the child a gift card with a specific value, or transferring money from a parent's account into a child's account. Once this transfer is complete to a child's account, the child has total control over how and where the money is spent. Someone other than the child who has access to the account, either legitimately or otherwise, has total access to the money as well.

An issuer is an institution which grants someone an account subject to limits that the issuer defines, including but not limited to credit limit and max transaction size per day. These limits are subject to change over time by approval by the issuer, but can not be controlled directly by the person or persons granted access.

An account holder is one who is registered with an issuer to use the account. The account holder accesses the account using an identifier associated with the account, an identifier associated with the account holder and security information associated with access to the account. In the prior art, once this information is entered the account holder has access to the account up to the limits set by the issuer.

An account user is a person who uses the account for one or more transactions. Normally this would be the same as the account holder, but the account holder could grant another person access by handing him or her the card along with the security information. In doing this, the account holder would have no control over the usage by the account user beyond the limit of either physical control of the card, or requesting the issue to issue another card.

A merchant is an entity which interacts with the account user to invoke a transaction. The merchant could be a financial organization such as a bank, or could be an organization that provides goods or services to the account user in exchange for getting value from the account user through the card.

Some issuers allow an account holder to generate a virtual financial instrument. The use of this virtual financial instrument may be limited by the issuer for a specific number of uses, a specific period of time, to transactions with a specific merchant, a specific credit limit, or any combination thereof. If the use is single-use, then a new identifier is generated online at the time of the request that is only good for one transaction. Once the number is generated, an account user can use the virtual financial instrument for online transactions after authenticating themselves. However, if the account user wants to use the virtual financial instrument for transactions in a physical location such as a store, bank or movie theatre, the issuer has to send the account holder a physical card. This is because a virtual financial instrument is not tangible, and so cannot be scanned or swiped by the point of sale equipment in a brick-and-mortar facility. The virtual financial instrument is limited to access an account holder's own accounts based on rules setup by the issuer. These rules are based around the account holder's current credit profile (i.e. max transactions per day, max value of any transaction, credit limit, etc) that the account holder has no control over. If the virtual financial instrument is multiple use, the account user has to carry around a credit card number/expiration date and card ID. These identifiers, if exposed to another individual, are vulnerable to use by that individual.

### SUMMARY

Methods and systems are disclosed for enabling participants to generate, use, and transfer virtual financial instruments. The account holder requests the generation of a virtual financial instrument. The account holder selects a financial instrument to use as the source of funds for the virtual financial instrument, configures the use of the virtual financial instrument to be limited by a set of user-defined rules and expiration date, and selects a user of the instrument. The virtual instrument is transferred to the user. On request to perform a financial transaction, the user is authenticated, the transaction is validated that it is in within the limits of the user-defined rules, an authorization code is request if it is not, and the transaction is allowed. If a chargeback is necessary, the virtual financial instrument and the account is updated if the instrument has not expired, just the account otherwise.

### BRIEF DESCRIPTION OF THE DRAWINGS

A better understanding of the present invention can be obtained from the following detailed description in conjunction with the following drawings, in which:

FIG. 1 illustrates the prior art.

FIG. 2 illustrates one embodiment of system which can process virtual financial instruments for mobile transfer.

FIG. 3 illustrates the process of a generating a virtual financial instrument for his own use.

FIG. 4 illustrates the process of generating a virtual financial instrument for the use by another individual.

The figures are provided in order to provide a thorough understanding of the present invention. The figures should not be construed as limiting the breath of the invention in any manner.

### DETAILED DESCRIPTION

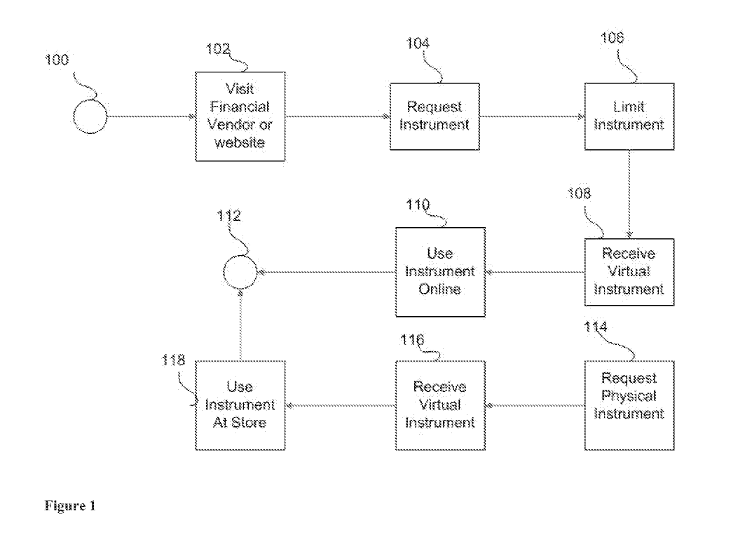

FIG. 1 shows a prior art process for obtaining and using a virtual financial instrument consisting of a 16-digit number, a Card Verification Value (CW), and an expiration date. When an account holder decides they need such an instrument, they start the process 100. The account holder visits an issuer or the issuer's website 102. The account holder is presented with a limited set of options around a physical card or electronically generated number which is good for a limited number of transactions, some limited amount of money, access to a limited number of merchants, access for some limited period of time or some combination thereof. Other limitations as set by the issuer are possible. The virtual financial instrument is requested by the user 104, the virtual financial instrument is created and limits set appropriately as defined by the issuer based on the parameters selected by the account holder 106. The virtual financial instrument is generated and sent to the account holder 108. At this point, the account holder may use the virtual financial instrument for online purposes 110. Forgetting or losing the number will result in loss of access to the value of the virtual financial instrument. If the account holder wishes to use the virtual financial instrument at some physical location such as a retail store or restaurant, the account holder must request a physical card from the issuer which is capable of being scanned 112. The issuer must generate and deliver such a card 114, at which point the physical card may be used for a point-of-sale transaction 116. If the account holder wishes to allow a third party to use the virtual financial instrument, the account holder is responsible for providing that third party with the instrument, including any and all Personal Identification Numbers (PINs) associated with that instrument. This third party would be a card user. However, the issuer would have no knowledge of the third party, nor would any merchant be able to ascertain that the third party as a card user has the proper authority to use the virtual financial instrument. This would require that the third party tell the user his or her secure information, such as PIN and billing address, or vice versa, in order for the third party to be verifiable to a merchant.

A PIN is a variable-length alphanumeric character sequence known to the user, and used for the purpose of associating the user with a secure device or card.

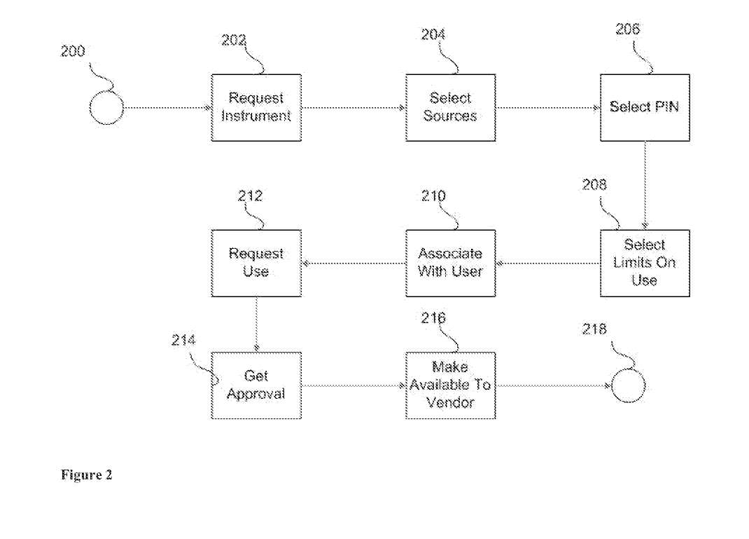

FIG. 2 illustrates one environment in which one or more embodiments of the invention may operate. However, not all of these components may be required to practice the invention, and variations in the arrangement and type of the components may be made without departing from the spirit or scope of the invention. An account holder decides he needs a virtual financial instrument and starts the process 200. The process may be executed in a variety of channels; on a website, via a phone using an IVR, or SMS. On requesting the instrument 202, the user is presented with a variety of sources to fund the virtual financial instrument, based on the resources they have available to them through their personal financial portfolio 204. In one or more embodiment this includes credit accounts, savings accounts, and prepaid cards. Once the account holder selects the source to associate with the virtual financial instrument, the account holder selects a PIN to associate with the virtual financial instrument 206. The account holder then can determine the limits on the use of the virtual financial instrument based on a set of rules which is defined independently of any one issuer. In one or more embodiments, the order of selecting the accounts and the rules is not critical, however, once the accounts are selected there may be conditions which invalidate the rules. For example, one cannot set a time limit on the virtual financial instrument that is longer than any selected account. The virtual financial instrument may be associated with this account holder, or the account holder may request it to be associated with another person he designates as the account user 210. Added security would allow the account holder to associate the instrument with that other user, using a picture of the other user, or a pin generated by the other user to encrypt the instrument information as part of the transfer.

If the account user is other than the account holder then the other user is notified that the instrument is available. The account user can be notified using any protocol for such as notification such as SMS, e-mail, voice notification, US Mail, etc. The account user would then get instructions along with this notification how to retrieve the financial instrument. In one or more embodiments, the account user would be required to enter a PIN or password which would enable them to access the financial instrument. In one or more embodiments, the instructions for access would include a code that the account user would enter which, in combination with the account user's PIN or password would unlock it. In one or more embodiments, a code could come to the user by a secondary channel, for instance a second e-mail, US Mail, etc. Should the account user refuse or otherwise be unavailable to accept the instrument, the financial credit and debit value would be returned to the account holder as unused. When the account user accepts the instrument, the security of the instrument would be based on the information (billing address, PIN) associated with that account user.

At some point, the account user would request use of the instrument 212. The account user enters his PIN and a response is returned displaying some combination of a value associated with the financial instrument and a value associated with the user. The value associated with the financial instrument could be a bar code or a number representing the identifier of the financial instrument, neither of which the user of the instrument has to know about. In one or more embodiment, a new identification code can be generated for each request regardless of the limits on the actual instrument. The value associated with the user could be a picture of the user, or some identifying ID such as the driver's license number or name of the account user that the merchant can check. Once the information is entered into the merchant's system, the efficacy of the transaction is based on the rules defined by the account holder 214. If the transaction is valid, the proper originating account is debited based on a set of rules defined at the time the instrument was created, the value of the transaction is transferred to the merchant 216, and the transaction is completed 218.

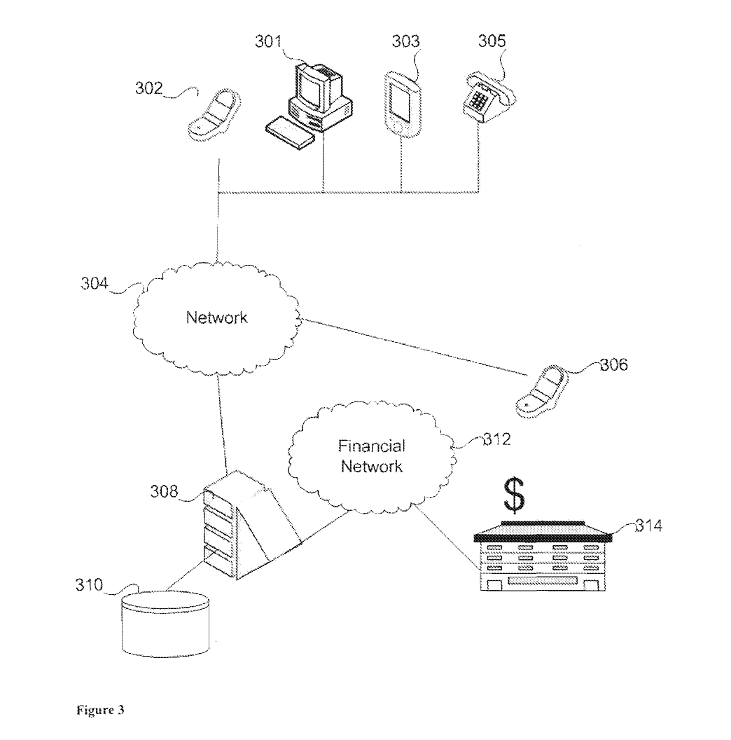

FIG. 3 shows one embodiment of the operating environment for generating a virtual financial instrument for an account holder. A remote input device such as a cell phone 302 is required to input the information about the virtual financial instrument. In one embodiment, any device that allows one to respond to text requests such as a telephony instrument that is connected to an IVR, a PDA, or a personal computer can be used. The input device 302 is connected to a processor 308 through a network 304 that is appropriate to the input device 302. The processor accepts the request, stores information about the virtual financial instrument in local storage 310. The processor 308 is connected to the financial network 312 to process financial transactions to and from the financial institutions 314. In some cases, the information about the virtual financial instrument is transferred to a second input device 306 or the same device 302 which then displays the financial instrument information for the vendor either in a graphical, textual, or combination format based on the capabilities of the device or limitations of the processing system.

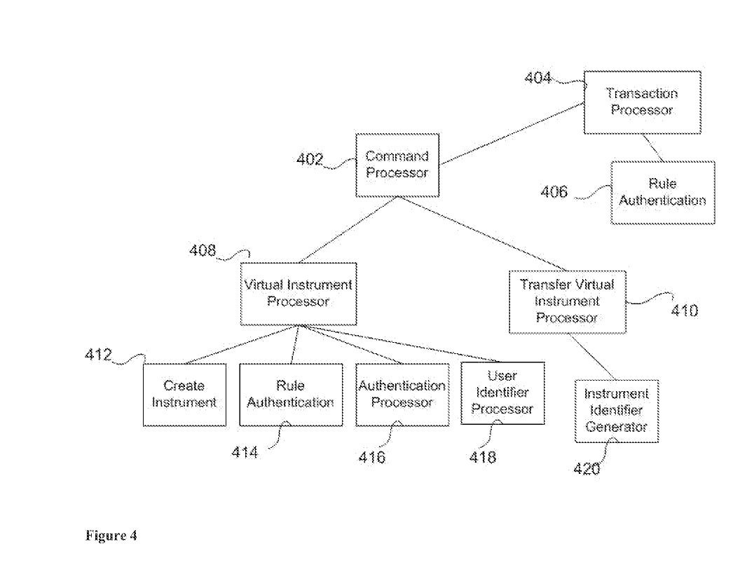

FIG. 4 shows an embodiment of the modules necessary to create the processing. It is understood by one skilled in the art that these modules may be software, may be hardware or some combination thereof. One or more modules will accept requests from input devices over the network 402. The request will be of the form to create a virtual financial instrument 408, get an existing virtual financial instrument 410, or process a transaction for a specific virtual instrument 404. When creating a virtual financial instrument 408, the module must generate the instrument 412, associate the instrument with a PIN and a unique identifier 416, and associated the instrument with a user 418. In one or more embodiments, when a request comes in to use a virtual financial instrument, a barcode graphic is generated as a result 420.

When creating a virtual financial instrument 412, the sources of the funds must be selected from those the system knows or can determine are associated with the card holder. If multiple sources are selected, the account holder must define the sequence the transaction processor should get funds from (i.e. first source, then when funds are unavailable from the first source, the second source, etc). In one or more embodiments, it is possible for the system to use its' own logic based on the characteristics of the sources. For instance, always spend from debit accounts before turning to credit, spend from the lower interest rate accounts first, from the lower minimum payment accounts first, and so forth. Once the instrument is defined, a valid credit card number, CVV number, and expiration date are assigned to the virtual financial instrument. In one or more embodiments, the expiration date is set by the user, but in no case can it be longer than that of the date for the latest available source of funds.

A rule may or may not be associated with the virtual financial instrument 414. The rule defines some set of limitations on the use of the card, the limitations including but not limited to the maximum number of transactions for the instrument, the maximum number of transactions in a user-specified time period, the maximum size of a transaction, or the maximum total amount transacted in a user-specified time period. In one or more embodiments, this could be an absolute limitation or a limit that can be overcome by an additional authentication code associated with the rule. For instance, in one or more embodiments, one can setup a rule associated with an additional authentication code that limits instrument use to 10 times a day and no more than $100 per transaction or $500 in a day. Another example, in one of more embodiments a second rule can be setup requiring no additional authentication code that limits instrument use to 15 times a day and no more than $1000 per day. In one or more embodiments, the rules are executed against the stored current state of the virtual financial instrument, which takes into account the series of transactions executed against the card, the card expiration date, and the current balance available.

The authentication processor 416 generates authentication codes to be associated with the instrument creation 412 or the rule 414. The authentication could be the same or different for each one. In one or more embodiments, the authentication codes could be PINs, passwords, or answers to challenge questions setup by the account holder.

The user identifier processor 418 generates an identifier that is then used to associate with the instrument with a user. In one or more embodiment the identifier is associated with user-specific information such as a picture, drivers license number, etc, that can then be used to generate a graphic on the client device and then used by a merchant to validate that this is the person who has access to this instrument.

In one or more embodiments if the card holder wishes to make the virtual financial instrument available to another user who is not an owner, the Transfer Virtual Instrument Processor 410 is used to enable a user other than the card holder to become the card user. The access to the card goes through a proxy; the access to the virtual instrument is based on the authentication in the virtual financial instrument system, not that of the card holder, so that access to the virtual instrument is first approved locally, then the transaction processor 404 acts as the original card holder with respect to the issuer to invoke the transactions. In order for this to happen, the authentication interaction with the card user is based on that user's authentication not that of the card holder. A new identifier is then created for the card user 420. In this way, once the transfer is complete, the card holder knows nothing about the card user's security and vice versa.

When a transaction is invoked, the transaction processor 404 will authenticate the user based on the identifier associated with the instrument. Whether that is that of the card holder 418 or the card user 420. Once the user is authenticated, then the transaction is validated through the rule 406. In one or more embodiments, the state of the virtual financial is updated to reflect the new transaction including any changes in the amount available to the user. If there is one or more rules associated with the virtual financial instrument, and the transaction exceeds the rule by exceeding the total number, the total number over some time period, the total value over some time period or total value for a given transaction, either the transaction will be denied if no authentication code is associated with it, or the user will be “challenged” to enter another authentication code which has no relationship to the one used to allow access to the card.

In one or more embodiments, chargebacks are processed based on the rules associated with the virtual card. For instance, if the virtual card is not expired, then the balance refunded should go back to the user rather than the owner. If the card is expired, then the balance goes back to the owner and it is up to the owner to provide a second virtual card to the user to spend the money if so desired.

In one or more embodiments, the owner can change the rules associated with a virtual card, including revocation (which is in effect a rule which makes it so that no transactions can occur in a given time period). In one or more embodiments, the owner can make a request to view all virtual cards generated by that owner. In one or more embodiments, the rule modification is executed in the same manner as it did during the issuance of the card, with the exception that the change is based on the known virtual card number rather than a number issued by the processor.

In order to process transaction using a virtual card which are dependent on rules, in one or more embodiments the state of the virtual card must be stored such that the processor can execute the rules independent of the state of the originating financial instrument. For instance, each transaction and the time of each transaction must be stored if rules limiting the number of transactions per day are to be executed. In one or more embodiments, this would also include the amount of each transaction, a running total of the amount spent on the virtual financial instrument (taking into account both charges and chargebacks), and the start and end times bounding the validity of the virtual financial instrument.

In one or more embodiments, programming instructions for executing above described methods and systems are provided. The programming instructions are stored in a computer readable media.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A method for the generation, use, and transfer of an virtual financial instruments, the user of which does not have to know any account-identifying information, implemented within a computer system comprising at least one CPU, a memory, a facility for data storage and a communication interface, the method comprising:
accepting a request to create a virtual financial instrument from a first user;
accepting a first account from the set of accounts from the first user;
associating the first account with the virtual financial instrument;
accepting an authentication data from the first user;
associating the authentication data with the virtual financial instrument;
associating the virtual financial instrument with a second user;
configuring a user-defined rule, wherein the user-defined rule comprises an authorization data and a combination of at least one of a limitation on the use of the virtual financial instrument, the limitations including the total number of transactions, the number of transactions in some time period, the value of a transaction, and the value of transactions in some time period;
associating an expiration date with the identifier of the second user;
transferring the virtual financial instrument to the second user;
accepting a financial transaction request from the second user, the request comprising a value and a first authentication response;
determining if the first authentication response is sufficient for the transaction based on the user-defined rule associated with the virtual financial instrument, wherein the authentication is considered insufficient if any of the limitations associated with the user-defined rule are exceeded by the transaction; and
requesting an authorization response if the authentication data is not sufficient, wherein the authorization response must match the authorization data for the transaction to be allowed.

2. The method in claim 1, further comprising:
displaying the set of accounts to the first user;
selecting a second account, not necessarily related to the institution associated with the first account, wherein if a transaction is rejected by the first account an attempt will be made to execute the transaction with the second account;
associating an identifier with the virtual financial instrument;
configuring an authentication data and associating the authentication data with the virtual financial instrument;
accepting an identifier of a second user to be associated with the virtual financial instrument;
accepting a graphic to associate with the identifier of the second user;
allowing the first user to configure the user-defined rule associated with the virtual financial instrument if the time of configuration is before the expiration date of the virtual financial instrument;
notifying the second user that the virtual financial instrument is available for their acceptance;
receiving an acceptance of the virtual financial instrument from the second user;
enabling the use of the virtual financial instrument by the second user upon receipt of the acceptance;
accepting transaction information from the second user, the transaction information comprising an amount, the identifier associated with the virtual financial instrument, and a first authentication response;
comparing the first authentication response against the first authentication data;
if first authentication response is equivalent to the first authentication response data, determining if the first authentication data is sufficient for the transaction,
wherein the authentication is considered insufficient if any of the limitations associated with the user-defined rule are exceeded by the transaction;
displaying the graphic associated with the second user;
storing the state of the virtual financial instrument including the date and time of transaction, amount of the transaction, and current balance available after processing the transaction; and
accepting a chargeback request, with the balance associated with the chargeback returned to the virtual financial instrument if the virtual financial instrument is not expired, or to the account otherwise.

3. The method in claim 2, further comprising:
generating a scannable image onto a client device on request, wherein the scannable image can be accepted by a point-of-sale terminal to provide the account information.

4. The method in claim 3, wherein the scannable image is a barcode.

5. The method in claim 1, the limitations of the user-defined rule further comprising:
a limitation associated with types of transactions to either include or exclude; and
a limitation associated with one or more vendors to either include or exclude.

6. An apparatus for enabling client devices to request the generation, use and transfer of virtual financial instruments, the user of which does not have to know any account-identifying information, the apparatus comprising:
a computer, comprising of a CPU, memory, a facility for storage, and a communications interface coupled to a network;
a first user storage, coupled to the computer, configured to store user identification information about a first user;
an account storage, coupled to the computer, configured to store account information about accounts associated with a first user;
a virtual instrument storage, coupled to the computer, configured to store instrument information about a virtual financial instrument, including identification data, account information, authentication information, current balance, and transactional data;
a rules storage, coupled to the computer, configured to store a user-defined rule and the association between the rule and a virtual financial instruments, wherein the user-defined rule comprises an authorization data and a combination of at least one of a limitation on the use of the virtual financial instrument, the limitations including the total number of transactions, the number of transactions in some time period, the value of a transaction, and the value of transactions in some time period;
a second user storage, coupled to the computer, configured to store user identification information about a second user, a virtual financial instrument associated with the second user, graphical information about a second user, and an expiration date associated with the association of the second user with the virtual financial instrument;
a virtual instrument module, coupled to the computer, configured to accept a request to create a virtual financial instrument, accept authentication data to associate with the virtual financial instrument, associate the virtual financial instrument with a first user, and store the virtual financial instrument information in the virtual instrument storage;
an account module, coupled to the computer, configured to display account information from the account storage, accept a first account to associate with a virtual financial instrument, and store the relationship between the account and virtual financial instrument in the virtual instrument storage;
a rules module, coupled to the computer, configured to accept a user-defined rule from a first user, associate a limitation with the user-defined rule, associate the user-defined rule with a virtual financial instrument, and store the user-defined rule in the rules storage;
a second user module, coupled to the computer, configured to accept user identification about a second user, associate the second user with the virtual financial instrument, accept an expiration date and associate it with the second user and virtual financial instrument, and storing the information in the second user storage;
a transfer module, coupled to the computer, configured to notify the second user that the virtual financial instrument is available for their acceptance, accepting their response or a timeout from the second user, and, if the response is received, activating the virtual financial instrument for use by the second user; and
a transaction module, coupled to the computer, configured to accept transaction data associated with a virtual financial instrument, authenticating the user against the authentication data stored in the virtual instrument storage, validating that the transaction is within the limitations of the user-defined rule, accepting authorization response and comparing it to the authorization data associated with the user defined rule, and storing the transaction data in the virtual instrument storage if the transaction is accepted.

7. The apparatus in claim 6, further comprising:
a chargeback module, coupled to the computer, configured to accept a chargeback request for a virtual financial instrument, updating the current balance and the transactional data in the virtual instrument storage if the expiration date has not passed, or with the one or more physical financial instruments otherwise;
a rules editor module, coupled to the computer, configured to display the user-defined rule associated with the virtual financial instrument from the rules storage, accepting editing commands to modify the user-defined rule, and storing the modified user-defined rule in the rules storage;
a graphic module, coupled to the computer, configured to accept a graphic to associate the second user with the virtual financial instrument, and storing the graphic in the second user storage; and
a scanning module, coupled to the computer, configured to generate a scannable image onto a client device,
wherein the scannable image can be accepted by a point-of-sale terminal to provide the account information.

8. The apparatus in claim 7, wherein the scannable image is a barcode.

9. The apparatus in claim 7, the limitations of the user-defined rule further comprising:
a limitation associated with types of transactions to either include or exclude; and
a limitation associated with one or more vendors to either include or exclude.

10. The apparatus in claim 6, the account module further configured to accept a second account, not necessarily related to the institution associated with the first account, wherein if a transaction is rejected by the first account an attempt will be made to execute the transaction with the second account.

11. A computer-readable media having programming instructions for the on-demand generation, use and transfer of virtual financial instruments, the user of which does not have to know any account-identifying information, the computer-readable media comprising:
programming instructions for accepting a request to create a virtual financial instrument from a first user;
programming instructions for accepting a first account from the set of accounts from the first user;
programming instructions for associating the first account with the virtual financial instrument;
programming instructions for accepting an authentication data from the first user;
programming instructions for associating the authentication data with the virtual financial instrument;
programming instructions for associating the virtual financial instrument with a second user;
programming instructions for configuring a user-defined rule, wherein the user-defined rule comprises an authorization data and a combination of at least one of a limitation on the use of the virtual financial instrument, the limitations including the total number of transactions, the number of transactions in some time period, the value of a transaction, and the value of transactions in some time period;
programming instructions for associating an expiration date with the identifier of the second user;
programming instructions for transferring the virtual financial instrument to the second user;
programming instructions for accepting a financial transaction request from the second user, the request comprising a value and a first authentication response;
programming instructions for determining if the first authentication response is sufficient for the transaction based on the user-defined rule associated with the virtual financial instrument, wherein the authentication is considered insufficient if any of the limitations associated with the user-defined rule are exceeded by the transaction; and
programming instructions for requesting an authorization response if the authentication data is not sufficient, wherein the authorization response must match the authorization data for the transaction to be allowed.

12. The computer readable media in claim 11, further comprising:
programming instructions for displaying the set of accounts to the first user;
programming instructions for selecting a second account, not necessarily related to the institution associated with the first account, wherein if a transaction is rejected by the first account an attempt will be made to execute the transaction with the second account;
programming instructions for associating an identifier with the virtual financial instrument;
programming instructions for configuring an authentication data and programming instructions for associating the authentication data with the virtual financial instrument;
programming instructions for accepting an identifier of a second user to be associated with the virtual financial instrument;
programming instructions for accepting a graphic to associate with the identifier of the second user;
programming instructions for allowing the first user to configure the user-defined rule associated with the virtual financial instrument if the time of configuration is before the expiration date of the virtual financial instrument;
programming instructions for notifying the second user that the virtual financial instrument is available for their acceptance;
programming instructions for receiving an acceptance of the virtual financial instrument from the second user;
programming instructions for enabling the use of the virtual financial instrument by the second user upon receipt of the acceptance;
programming instructions for accepting transaction information from the second user, the transaction information comprising an amount, the identifier associated with the virtual financial instrument, and a first authentication response;
programming instructions for comparing the first authentication response against the first authentication data;
if first authentication response is equivalent to the first authentication response data, programming instructions for determining if the first authentication data is sufficient for the transaction,
wherein the authentication is considered insufficient if any of the limitations associated with the user-defined rule are exceeded by the transaction;
displaying the graphic associated with the second user;
programming instructions for storing the state of the virtual financial instrument including the date and time of transaction, amount of the transaction, and current balance available after processing the transaction; and
programming instructions for accepting a chargeback request, with the balance associated with the chargeback returned to the virtual financial instrument if the virtual financial instrument is not expired, or to the account otherwise.

13. The computer readable media in claim 11, wherein the scannable image is a barcode.

14. The computer readable media in claim 11, wherein the generation of the scannable image further comprises programming instructions for generating the graphic associated with the end-user.
